(19) United States
(12) Patent Application Publication
(10) Pub. No.: US 2020/0358201 A1
(43) Pub. Date: Nov. 12, 2020

(54) ANTENNA FOR HIGH REFLECTION ENVIRONMENTS

(71) Applicant: Honeywell International Inc., Morris Plains, NJ (US)

(72) Inventor: Christopher Coy Fuller, Bloomington, MN (US)

(21) Appl. No.: 16/406,668

(22) Filed: May 8, 2019

(51) Int. Cl. H01Q 19/15; H01Q 1/24; H01Q 25/02

(52) U.S. Cl. CPC H01Q 19/15; H01Q 25/02; H01Q 1/247

(57) ABSTRACT

A radar system is used to implement a method. The method includes transmitting radar signals from a radar system located in an environment having reflective surfaces, receiving reflected signals via an antenna, deriving angular information as a function of the antenna configuration, and providing an output as a function of the received reflected signals and the derived angular information, wherein the output is representative of a characteristic of the environment. The antenna may be a patch antenna with patches having overlapping gain patterns or patches arranged as a leaky wave antenna to provide information in received signals from which angular information is derivable.

### BACKGROUND

Radar systems for indoor environments encounter the presence of a high level of reflections from interior structures, including objects which may be placed near a radar system. The nearby objects may result in a very high level of reflections, limiting the sensitivity of the radar system.

### SUMMARY

A radar system is used to implement a method. The method includes transmitting radar signals from a radar system located in an environment having reflective surfaces, receiving reflected signals via an antenna, deriving angular information as a function of the antenna configuration, and providing an output as a function of the received reflected signals and the derived angular information, wherein the output is representative of a characteristic of the environment. The antenna may be a patch antenna with patches having overlapping gain patterns or patches arranged as a leaky wave antenna to provide information in received signals from which angular information is derivable.

### BRIEF DESCRIPTION OF THE DRAWINGS

FIG. 1 is a block schematic representation of a radar system positioned in an indoor environment according to an example embodiment.

FIG. 2 is a block schematic representation of a radar system having an antenna suitable for an environment having a high level of reflections according to an example embodiment.

FIG. 3 is a block schematic representation of a patch antenna for use in the radar system of FIG. 2 according to an example embodiment.

FIG. 4 is a block diagram representation of a leaky wave antenna for use in the radar system of FIG. 2 according to an example embodiment.

FIG. 5 is a flowchart illustrating a method of operating the radar system of FIG. 2 in an environment having a high level of reflections according to an example embodiment.

FIG. 6 is a block schematic diagram of a computer system to implement one or more example embodiments.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software in one embodiment. The software may consist of computer executable instructions stored on computer readable media or computer readable storage device such as one or more non-transitory memories or other type of hardware based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, circuitry, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term, “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Radar systems for indoor environments encounter a high level of reflections from walls and objects, such as furniture and other objects within a structure, such as a home or business. Nearby objects can result in a very high level of reflections from the environment, which limit the sensitivity of the radar system. Angle information from radar reflections can be very useful in for the radar system to work well in such environments.

Reflected radio waves are useful in a way similar to how reflected light is useful to a camera for detecting and identifying objects within the view. The images may be analyzed by a human for useful information or by automated algorithms for detecting and identifying objects and people of interest, which may include gestures, and behaviors. While radar images may sometimes not look at all familiar to us compared to video images, the patterns of detections are useful for training algorithms to automatically detect and identify objects and people and for reliably detecting and identifying objects and people.

In various embodiments of the present inventive subject matter, angle information providing monopulse antennas may be used in radar systems to provide angle information useful in improving the sensitivity of the radar systems in highly reflective environments. Sum and difference signals used by monopulse antennas may be generated via RF circuits within or adjacent to the antennas.

Patch antennas configured to combine received radar signals from antenna patches provide angular information for use in imaging, target identification, gesture recognition, tracking for security, comfort, home health, and other applications.

In a further embodiment, a leaky wave antenna may be used to provide directional gain that changes as an operating frequency of the antenna is changed. Using a leaky wave antenna in an indoor environment is advantageous for similar applications due to their low cost and reduction of clutter in the view of the antenna as compared to broad-beam antennas typically used for indoor sensing applications. By reducing the magnitude of reflections back to the source of a monostatic radar or to a bi-static radar, the transmit power may be maximized in order to maximize the sensitivity of the radar to sensing the environment. A phased-array-like character of the leaky wave antenna also provides improved resolution. By varying a transmit frequency, an angle of maximum radiation from the leaky wave antenna is varied, providing sufficient angular information. The variation of frequency also allows higher powers of transmission without overloading a receiver. Higher transmit power is possible because the instantaneous radar energy received is distributed over a space as the transmitter frequency varies, thus lowering the local concentration of energy at the receiver. For a receiver in a fixed location, the received energy depends upon the amount of space over which the transmitted signal is spread.

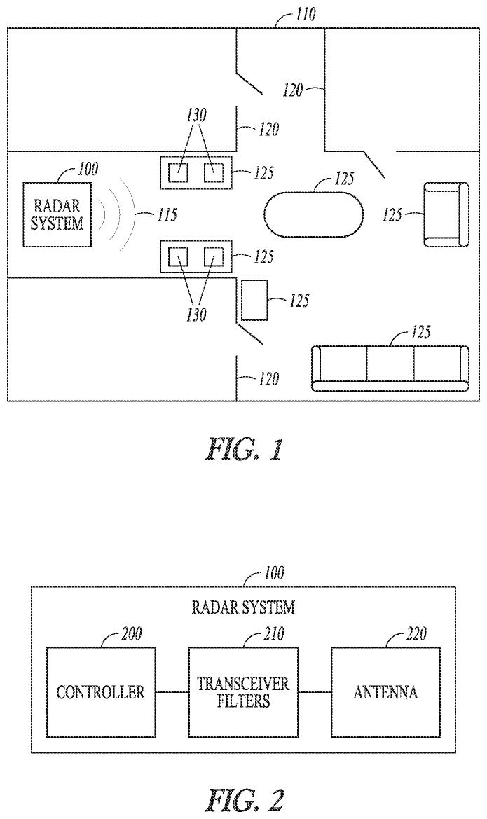

FIG. 1 is a block schematic representation of a radar system 100 positioned in an environment 110 according to an example embodiment. The radar system emits radar signals 115 into the environment 110 and receives and processes reflected radar signals. The environment 110 in one embodiment is an indoor environment having multiple objects such as walls 120, furniture 125, stuff 130 on or thereon, all contributing to high levels of reflection.

The received radar signals are processed based on signals strength and derived angular information to provide an output. The output is representative of one or more characteristics of the room. The output may include indications of presence in a room, gestures of a user to control an application or device, identification of objects, such as people, or things, security, comfort and health information for applications, and images for display or storage. One or more of such indications are characteristics that the radar system can provide representations of as the output.

FIG. 2 is a block schematic representation of the radar system 100 of FIG. 1. Radar system 100 includes a controller 200, a transceiver 210 that may also include one or more filters for processing of received signals, and an antenna 220 suitable for an environment having a high level of reflections according to an example embodiment. In one embodiment, the antenna 220 is one capable of providing angular information that may be used to improve sensitivity of the radar in and reduce the effects of reflections due to objects in the structure 110. The angular information may be along one axis or multiple axes. The angular information is associated with a range and/or range-rate and/or reflection amplitude detections of the radar, defining the two-dimensional or three-dimensional “pixel” image of region “imaged” by the radar.

Radar system 100 may be used to perform a method that includes transmitting radar signals in an environment having reflective surfaces. The reflective surfaces may be thought as highly reflective in that the environment has more reflective surfaces than many outdoor environments. An example of such an environment includes a room, home, or building. Reflected signals are received via the antenna. Angular information is derived as a function of the antenna configuration. Radar system 100 then provides an output as a function of the received reflected signals and the derived angular information, wherein the output is representative of a characteristic of the environment.

In one embodiment the antenna comprises a patch antenna. The angular information is derived from signals received at pairs of patches of the patch antenna. In further detail, the angular information is derived from signal gain received at multiple patches having gain patterns oriented such that gain versus angle partially overlaps along at least one axis. In various embodiments, angle information may be computed (often by interpolation or curve fit) from a table calibrated from the antenna difference divided by the SUM (often referred to as DOS in the literature). Difference and sum in RF may be routinely calculated via hybrid couplers, transformers, discrete networks and other methods.

In further embodiments, the antenna comprises a leaky wave antenna, which may be in the form of a patch antenna having patches and conductive traces between patches arranged to cause leaky mode effects. The method may include varying a frequency of the transmitted radar signals to vary an angle of maximum radiation of such signals from the leaky wave antenna as a function of the frequency. Deriving the angular information is performed as a function of the angle of maximum radiation for each reflected signal at the varied frequencies.

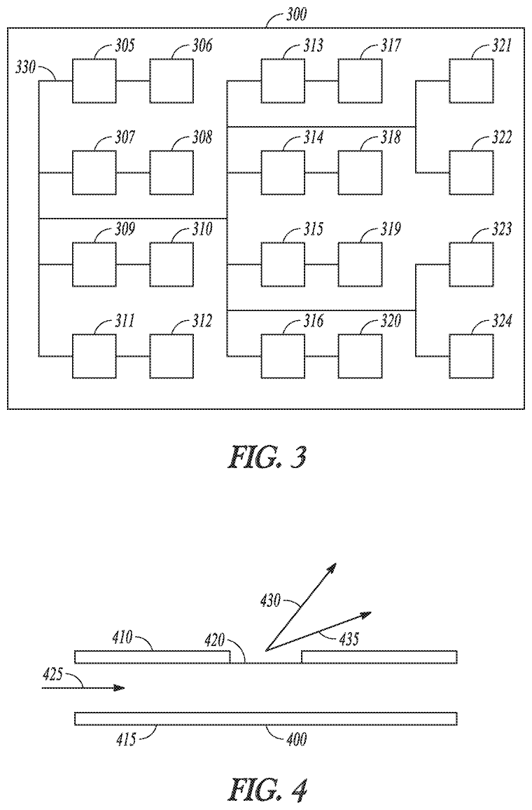

FIG. 3 is a block schematic representation of a patch antenna for use in the radar system of FIG. 2 according to an example embodiment. The patch antenna 300 includes multiple antenna patches indicated at 305, 306, 307, 308, 309, 310, 311, 312, 313, 314, 315, 316, 317, 318, 319, 320, 321, 322, 323, and 324. The antenna patches may be supported on a circuit board and coupled by conductive traces 330. The patches may be positioned and coupled via the traces 303 to form log-periodic type antennas with gain patterns designed and oriented so the gain versus angle at least partially overlaps on one or multiple axes.

The use of multiple antennas may all be part of one detection system or may be from multiple systems which share data on detection of signals. Processing of received signals may occur on an individual system measuring all received signals or may occur in a central computing system such as server or cloud-based computing system.

FIG. 4 is a block cross section diagram representation of a leaky wave antenna 400 for use in the radar system 100 according to an example embodiment. Leaky wave antenna 400 is just one type of leaky wave antennas capable of providing angular information. Others include at least a type of patch antenna where the size and characteristics of the substrate are combined with metal patches and feed traces on the circuit board to cause leaky mode effects. The leaky mode effects result in the angle of maximum radiation from the antenna to vary as the transmit frequency is changed.

Antenna 400 as illustrated in FIG. 4 is a different example of a leaky wave antenna and comprises a rectangular waveguide with side walls 410 and 415, along with a slot 420 in side wall 410 from which radiation 425 provided to the waveguide emits as illustrated by first arrow 430 corresponding to a frequency f1. As the frequency is varied to f2, the emitted radiation occurs at a different angle as illustrated by arrow 435, the angle of the arrow/radiation changes, providing the ability to obtain angular information from the reflected radar received by the antenna.

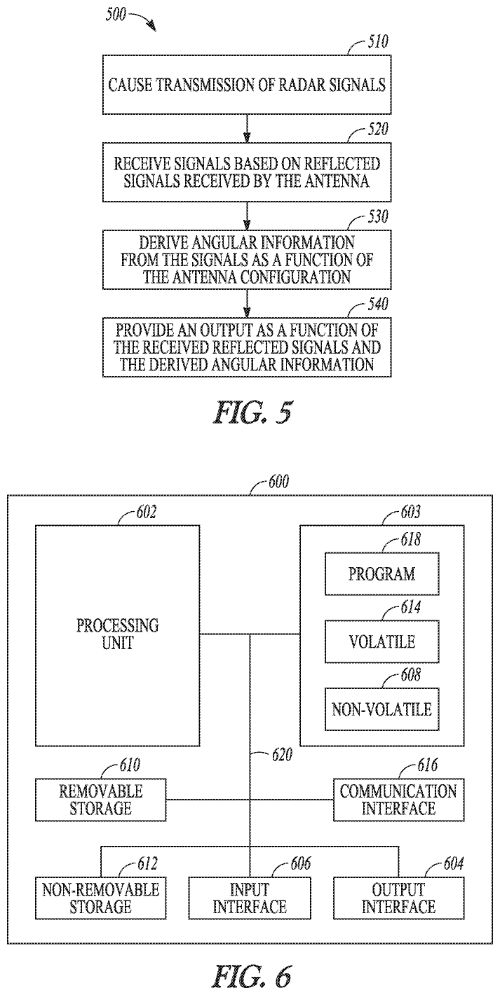

FIG. 5 is a flowchart illustrating a method 500 of operating the radar system 100 in an environment having a high level of reflections according to an example embodiment. Method 500 may be at least partially performed by controller 200 via programmed processor and/or circuitry. At operation 510, the controller causes transmission of radar signals by the antenna. The controller receives signals based on reflected signals received by the antenna at operation 520. At operation 530 the controller derives angular information from the signals as a function of the antenna configuration. The controller then provides an output as a function of the received reflected signals and the derived angular information at operation 540, wherein the output is representative of a characteristic of the environment.

The antenna may be a patch antenna with the angular information is derived from signals received by pairs of patches of the patch antenna. The angular information is derived from signal gain received at multiple patches having gain patterns oriented such that gain versus angle partially overlaps. In one embodiment, operation 530 is performed by generating a sum of signals received from pairs of patches, generating difference signals from the pairs of patches, and determining an angle of the detection from the sum and difference signals.

In a further embodiment, the antenna comprises a leaky wave antenna. The leaky wave antenna comprises a patch antenna having patches and conductive traces between patches arranged to cause leaky mode effects. Operations further include varying a frequency of the transmitted radar signals to vary an angle of maximum radiation of such signals from the leaky wave antenna as a function of the frequency. Deriving the angular information is performed as a function of the angle of maximum radiation for each reflected signal at the varied frequencies.

The radar system 100 may generate a plurality of time, range, angle, range-rate and amplitude signals from the received signals by processing pulsed, frequency-modulated-continuous-wave or other modulation types which may include the use of Fast-Fourier-Transforms, reductions of data by a variety of methods (e.g. Constant-False-Alarm-Rate or association of similar and nearby detections), and possibly further radar processing to refine the results.

The environment emissions may also be passed through a filter to detect patterns of interest in the processed environmental emissions, and to limit the number of patterns to limit a number which the radar system may processor within an available time. The filter may also determine the range, directional angle, or reflectivity of each portion of each pattern of interest. The radar system 100 may also use a variety of detection methods, including squelch, Constant False Alarm Rate (CFAR), blob detection, windowing, and other techniques in combination or individually for generating and disposition of patterns of interest.

In one embodiment, the signals received by the controller may be processed using a trained machine learning system. The system may be trained with example input vectors comprising digitized signals received by the antennas along with labels corresponding to various known characteristics of the environment. Machine learning models may be trained on associations of radar detections (blobs) to recognize them as people, or particular individuals, gestures, etc. The pixel resolution is in 3D instead of 2D which helps, but the number of pixels is often less compared to camera images due to memory and processing power limitations. The models work well for a staring radar such as might be used in a home which collects long-term statistical information on empty vs. non-empty homes. By staring for a long-time, the radar can ‘subtract’ the highly complex background environment to detect anything that changed, even very slightly, 0.5 dB, with very high probability (>99%) of knowing the change is real. Persistence may be included in the machine learning model to take advantage of persistence.

In further embodiments, radar detections may be combined with independent image detection from one or more cameras or radars. Two separate models may be used, one for camera images, and the other for radar images. The models may provide predictions with confidence values. The predictions with the highest confidence may be used, or a combination of the predictions weighted based on their confidence may be used to generate a final prediction of the characteristic of the environment. The images may be combined to improve detections and multiple radars may work together to obtain additional images via one radar transmitting while the other listens (bistatic) to improve images and detections.

FIG. 6 is a block schematic diagram of a computer system 600 to implement radar processing and system functions to perform methods and algorithms according to example embodiments. All components need not be used in various embodiments.

One example computing device in the form of a computer 600 may include a processing unit 602, memory 603, removable storage 610, and non-removable storage 612. Although the example computing device is illustrated and described as computer 600, the computing device may be in different forms in different embodiments. For example, the computing device may instead be a smartphone, a tablet, smartwatch, smart storage device (SSD), or other computing device including the same or similar elements as illustrated and described with regard to FIG. 6. Devices, such as smartphones, tablets, and smartwatches, are generally collectively referred to as mobile devices or user equipment.

Although the various data storage elements are illustrated as part of the computer 600, the storage may also or alternatively include cloud-based storage accessible via a network, such as the Internet or server-based storage. Note also that an SSD may include a processor on which the parser may be run, allowing transfer of parsed, filtered data through 1/0 channels between the SSD and main memory.

Memory 603 may include volatile memory 614 and non-volatile memory 608. Computer 600 may include—or have access to a computing environment that includes—a variety of computer-readable media, such as volatile memory 614 and non-volatile memory 608, removable storage 610 and non-removable storage 612. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 600 may include or have access to a computing environment that includes input interface 606, output interface 604, and a communication interface 616. Output interface 604 may include a display device, such as a touchscreen, that also may serve as an input device. The input interface 606 may include one or more of a touchscreen, touchpad, mouse, keyboard, camera, radar, one or more device-specific buttons, one or more sensors integrated within or coupled via wired or wireless data connections to the computer 600, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 600 are connected with a system bus 620.

Computer-readable instructions stored on a computer-readable medium are executable by the processing unit 602 of the computer 600, such as a program 618. The program 618 in some embodiments comprises software to implement one or more radar processing or radar system functions. A hard drive, CD-ROM, and RAM are some examples of articles including a non-transitory computer-readable medium such as a storage device. The terms computer-readable medium and storage device do not include carrier waves to the extent carrier waves are deemed too transitory. Storage can also include networked storage, such as a storage area network (SAN). Computer program 618 along with the workspace manager 622 may be used to cause processing unit 602 to perform one or more methods or algorithms described herein.

### EXAMPLES

1. A method includes transmitting radar signals from a radar system located in an environment having reflective surfaces, receiving reflected signals via an antenna, deriving angular information as a function of the antenna configuration and providing an output as a function of the received reflected signals and the derived angular information, wherein the output is representative of a characteristic of the environment.
2. The method of example 1 wherein the antenna comprises a patch antenna.
3. The method of example 2 wherein the angular information is derived from signals received at pairs of patches of the patch antenna.
4. The method of any of examples 2-3 wherein the angular information is from signal gain received at multiple patches having gain patterns oriented such that gain versus angle partially overlaps.
5. The method of example 4 and further including generating a sum of signals received from pairs of patches, generating difference signals from the pairs of patches, and determining an angle of the detection from the sum and difference signals.
6. The method of any of examples 1-5 wherein the antenna comprises a leaky wave antenna.
7. The method of example 6 wherein the leaky wave antenna comprises a patch antenna having patches and conductive traces between patches arranged to cause leaky mode effects.
8. The method of any of examples 6-7 and further comprising varying a frequency of the transmitted radar signals to vary an angle of maximum radiation of such signals from the leaky wave antenna as a function of the frequency.
9. The method of example 8 wherein deriving the angular information is performed as a function of the angle of maximum radiation for each reflected signal at the varied frequencies.
10. A radar system includes a transceiver to generate signals and receive signals, an antenna coupled to the transceiver to transmit radar signals based on the generated signals and provide signals to the receiver based on received reflected radar signals, and a controller coupled to the transceiver and perform operations. The operations include causing transmission of radar signals by the antenna, receiving signals based on reflected signals received by the antenna, deriving angular information as a function of the antenna configuration, and providing an output as a function of the received reflected signals and the derived angular information, wherein the output is representative of a characteristic of the environment.
11. The system of example 10 wherein the antenna comprises a patch antenna.
12. The system of example 11 wherein the angular information is derived from signals received by pairs of patches of the patch antenna.
13. The system of any of examples 11-12 wherein the angular information is derived from signal gain received at multiple patches having gain patterns oriented such that gain versus angle partially overlaps.
14. The system of example 13 wherein the operations further include generating a sum of signals received from pairs of patches, generating difference signals from the pairs of patches, and determining an angle of the detection from the sum and difference signals.
15. The system of any of examples 10-14 wherein the antenna comprises a leaky wave antenna.
16. The system of example 15 wherein the leaky wave antenna comprises a patch antenna having patches and conductive traces between patches arranged to cause leaky mode effects.
17. The system of any of examples 15-16 wherein the operations further comprise varying a frequency of the transmitted radar signals to vary an angle of maximum radiation of such signals from the leaky wave antenna as a function of the frequency.
18. The system of example 17 wherein deriving the angular information is performed as a function of the angle of maximum radiation for each reflected signal at the varied frequencies.
19. A machine-readable storage device has instructions for execution by a processor of a machine to cause the processor to perform operations to perform a method of managing communication accounts. The operations include causing transmission of radar signals by the antenna, receiving signals based on reflected signals received by the antenna, deriving angular information as a function of the antenna configuration, and providing an output as a function of the received reflected signals and the derived angular information, wherein the output is representative of a characteristic of the environment.
20. The device of example 19 wherein the antenna comprises a patch antenna, wherein the angular information is derived from signal gain received at multiple patches having gain patterns oriented such that gain versus angle partially overlaps, and wherein the operations further include generating a sum of signals received from pairs of patches, generating difference signals from the pairs of patches, and determining an angle of the detection from the sum and difference signals.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
transmitting radar signals from a radar system located in an environment having reflective surfaces;
receiving reflected signals via an antenna;
deriving angular information as a function of the antenna configuration; and
providing an output as a function of the received reflected signals and the derived angular information, wherein the output is representative of a characteristic of the environment.

2. The method of claim 1 wherein the antenna comprises a patch antenna.

3. The method of claim 2 wherein the angular information is derived from signals received at pairs of patches of the patch antenna.

4. The method of claim 2 wherein the angular information is from signal gain received at multiple patches having gain patterns oriented such that gain versus angle partially overlaps.

5. The method of claim 4 and further comprising:
generating a sum of signals received from pairs of patches;
generating difference signals from the pairs of patches; and
determining an angle of the detection from the sum and difference signals.

6. The method of claim 1 wherein the antenna comprises a leaky wave antenna.

7. The method of claim 6 wherein the leaky wave antenna comprises a patch antenna having patches and conductive traces between patches arranged to cause leaky mode effects.

8. The method of claim 6 and further comprising varying a frequency of the transmitted radar signals to vary an angle of maximum radiation of such signals from the leaky wave antenna as a function of the frequency.

9. The method of claim 8 wherein deriving the angular information is performed as a function of the angle of maximum radiation for each reflected signal at the varied frequencies.

10. A radar system comprising:
a transceiver to generate signals and receive signals;
an antenna coupled to the transceiver to transmit radar signals based on the generated signals and provide signals to the receiver based on received reflected radar signals; and
a controller coupled to the transceiver and perform operations comprising:
causing transmission of radar signals by the antenna;
receiving signals based on reflected signals received by the antenna;
deriving angular information as a function of the antenna configuration; and
providing an output as a function of the received reflected signals and the derived angular information, wherein the output is representative of a characteristic of the environment.

11. The system of claim 10 wherein the antenna comprises a patch antenna.

12. The system of claim 11 wherein the angular information is derived from signals received by pairs of patches of the patch antenna.

13. The system of claim 11 wherein the angular information is derived from signal gain received at multiple patches having gain patterns oriented such that gain versus angle partially overlaps.

14. The system of claim 13 wherein the operations further comprise:
generating a sum of signals received from pairs of patches;
generating difference signals from the pairs of patches; and
determining an angle of the detection from the sum and difference signals.

15. The system of claim 10 wherein the antenna comprises a leaky wave antenna.

16. The system of claim 15 wherein the leaky wave antenna comprises a patch antenna having patches and conductive traces between patches arranged to cause leaky mode effects.

17. The system of claim 15 wherein the operations further comprise varying a frequency of the transmitted radar signals to vary an angle of maximum radiation of such signals from the leaky wave antenna as a function of the frequency.

18. The system of claim 17 wherein deriving the angular information is performed as a function of the angle of maximum radiation for each reflected signal at the varied frequencies.

19. A machine-readable storage device having instructions for execution by a processor of a machine to cause the processor to perform operations to perform a method of managing communication accounts, the operations comprising:
causing transmission of radar signals by the antenna;
receiving signals based on reflected signals received by the antenna;
deriving angular information as a function of the antenna configuration; and
providing an output as a function of the received reflected signals and the derived angular information, wherein the output is representative of a characteristic of the environment.

20. The device of claim 19 wherein the antenna comprises a patch antenna, wherein the angular information is derived from signal gain received at multiple patches having gain patterns oriented such that gain versus angle partially overlaps, and wherein the operations further comprise:
generating a sum of signals received from pairs of patches;
generating difference signals from the pairs of patches; and
determining an angle of the detection from the sum and difference signals.
